(19) United States
(12) Patent Application Publication
(10) Pub. No.: US 2024/0280782 A1
(43) Pub. Date: Aug. 22, 2024

(54) LENS APPARATUS AND IMAGING APPARATUS

(71) Applicant: CANON KABUSHIKI KAISHA, Tokyo (JP)

(72) Inventor: TORU MATSUMOTO, Tochigi (JP)

(21) Appl. No.: 18/439,587

(22) Filed: Feb. 12, 2024

(30) Foreign Application Priority Data
Feb. 16, 2023 (JP) 2023-022700

(51) Int. Cl. G02B 7/09; G02B 13/18

(52) U.S. Cl. CPC G02B 7/09; G02B 13/18

(57) ABSTRACT

A lens apparatus includes a holding frame configured to hold a first lens, a driving unit configured to drive the holding frame in a direction along an optical axis, and a mount configured to mount the lens apparatus on an imaging apparatus. When the lens apparatus is viewed from the direction along the optical axis, at least a part of the driving unit is disposed inside a circumscribed circle of the first lens having a non-circular shape. A part of the first lens is disposed at a location that overlaps an object-side end surface of the mount or is disposed closer to an image plane than the object-side end surface of the mount in the direction along the optical axis.

### BACKGROUND

### Field of the Disclosure

The present disclosure relates to a lens apparatus and an imaging apparatus.

### Description of the Related Art

A lens apparatus including a non-circular lens has conventionally been proposed. Japanese Patent Application Laid-Open No. 2013-125233 discusses a lens apparatus including a non-circular lens, which is obtained by partially cutting out the outer circumference of a circular lens, and a driving unit disposed in the cutout area.

However, Japanese Patent Application Laid-Open No. 2013-125233 does not discuss a mount for mounting the lens apparatus on a camera body, or a relationship between the location of such a mount and the locations of the lens and the driving unit in the optical axis direction of the lens apparatus. Thus, the lens apparatus may increase in size, depending on the location where the lens and driving unit are disposed.

### SUMMARY

According to an aspect of the present disclosure, a lens apparatus includes a holding frame configured to hold a first lens, a driving unit configured to drive the holding frame in a direction along an optical axis, and a mount configured to mount the lens apparatus on an imaging apparatus. When the lens apparatus is viewed from the direction along the optical axis, at least a part of the driving unit is disposed inside a circumscribed circle of the first lens having a non-circular shape. A part of the first lens is disposed at a location that overlaps an object-side end surface of the mount or is disposed closer to an image plane than the object-side end surface of the mount in the direction along the optical axis.

Further features of the present disclosure will become apparent from the following description of exemplary embodiments with reference to the attached drawings.

### BRIEF DESCRIPTION OF THE DRAWINGS

FIG. 1 is a block diagram illustrating a configuration of a camera system including a lens apparatus.

FIG. 2 is a sectional view of the lens apparatus in an infinite state.

FIG. 3 is a sectional view of the lens apparatus in a close-up state.

FIG. 4 is a perspective view of a cam barrel and a driving unit.

FIG. 5 is a plan view of a non-circular lens.

FIG. 6 illustrates the lens apparatus (some parts thereof are not illustrated) viewed from an image side.

### DESCRIPTION OF THE EMBODIMENTS

Hereinafter, an exemplary embodiment of the present disclosure will be described in detail based on the drawings. In the drawings, like numbers refer to like elements, and redundant descriptions thereof will be omitted.

### (Configuration of Camera System)

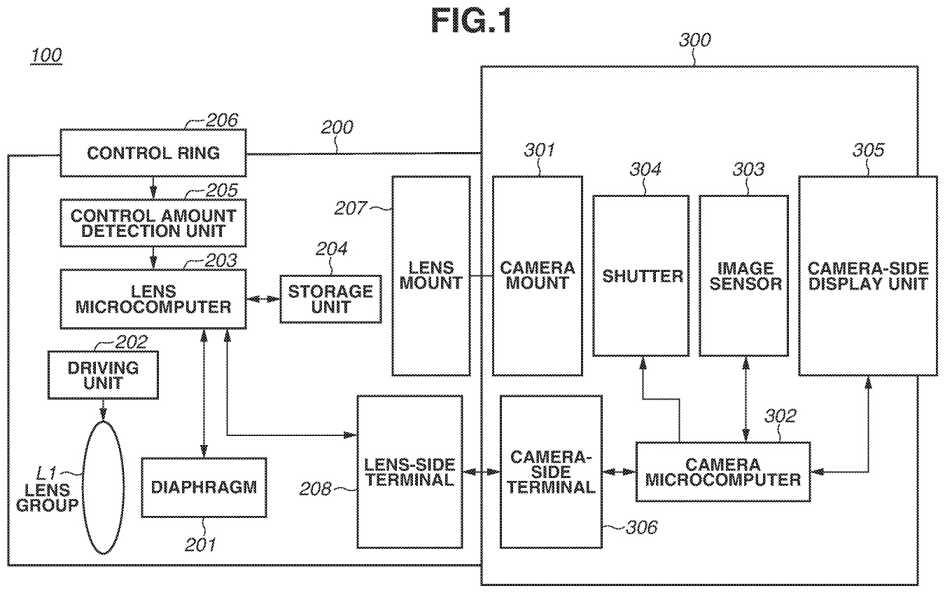

A configuration of an interchangeable lens 200 (an interchangeable lens for a camera), which is a lens apparatus according to an exemplary embodiment of the present disclosure, will be described with reference to FIG. 1.

FIG. 1 is a block diagram illustrating a configuration of a camera system 100 including the interchangeable lens 200 as the lens apparatus according to the exemplary embodiment of the present disclosure. The camera system 100 includes the interchangeable lens 200 and a camera body 300 as a lens-interchangeable-type imaging apparatus to which the interchangeable lens 200 is detachably attached.

The interchangeable lens 200 includes a lens group L1, a diaphragm 201, a driving unit 202 as driving means, a lens microcomputer 203 as a control unit, a storage unit 204, a control amount detection unit 205, and a control ring 206. The diaphragm 201 adjusts the quantity of light. The driving unit 202 drives the lens group L1. The driving unit 202 is controlled by the lens microcomputer 203. The lens microcomputer 203 is a microcomputer, such as a micro processing unit (MPU). The lens microcomputer 203 can communicate with the storage unit 204 and the control amount detection unit 205.

The control amount detection unit 205 electrically detects the rotational position and the control amount of the control ring 206. The control ring 206 is held by the interchangeable lens 200 rotatably around the optical axis of the lens group L1 (in the circumferential direction). The control ring 206 has no stroke end in the rotation direction and is infinitely rotatable. A known method may be used to detect the rotational position and the control amount of the control ring 206, and detailed description thereof will be omitted.

When the control ring 206 rotates (turns) around the optical axis, the control amount detection unit 205 outputs a signal corresponding to the rotation amount (turning amount) to the lens microcomputer 203. The lens microcomputer 203 drives a control target by using the signal. The control target of the control ring 206 can be changed by a setting operation. The control ring 206 drives the lens group L1, the diaphragm 201, and another component in accordance with a setting operation.

The interchangeable lens 200 includes a lens mount 207, as a connection unit for connection to the camera body 300, and a lens-side terminal 208 (terminal unit) as a communication unit for communication with the camera body. The camera body 300 includes a camera mount 301, a camera microcomputer 302 as a control unit, an image sensor 303, a shutter 304, a camera-side display unit 305, and a camera-side terminal 306.

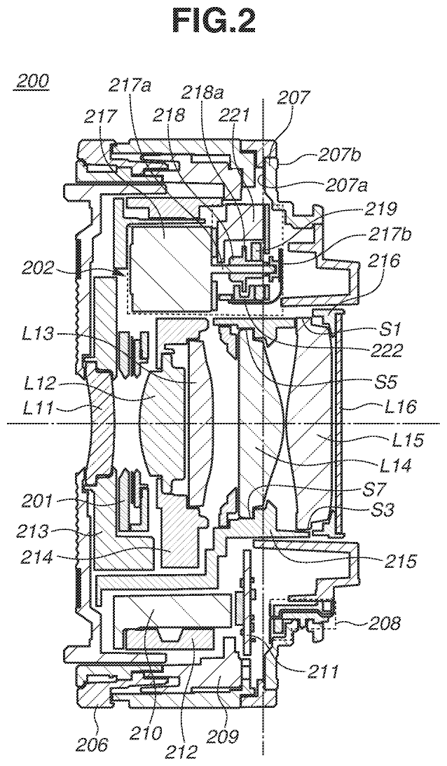

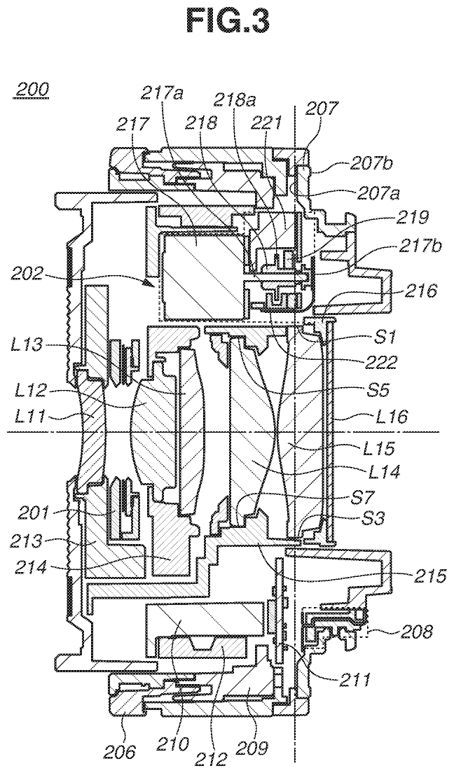

The interchangeable lens 200 and the camera body 300 are detachably attached to each other via the lens mount 207 and the camera mount 301. The lens mount 207 includes an object-side end surface 207a and a camera contact surface 207b that comes into contact with the camera mount 301 (see FIGS. 2 and 3).

The camera body 300 can play back (display) an image obtained by the image sensor 303 on the camera-side display unit 305 via the camera microcomputer 302. The camera-side display unit 305 can also display information, such as the setting state of the interchangeable lens 200. The camera microcomputer 302 controls imaging conditions, such as the International Organization for Standardization (ISO) sensitivity, white balance of the image sensor 303, and the speed of the shutter 304, as settings for the camera body.

The camera microcomputer 302 is connected to the lens microcomputer 203 via the lens-side terminal 208 and the camera-side terminal 306 such that the camera microcomputer 302 and the lens microcomputer 203 can communicate with each other. Alternatively, the lens microcomputer 203 and the camera microcomputer 302 are not necessarily provided as separate units. The lens microcomputer 203 and the camera microcomputer 302 may be provided as a single micro-processing unit (MPU), instead of being connected to each other via the lens-side terminal 208 and the camera-side terminal 306.

### (Configuration of Lens Apparatus)

A configuration of the interchangeable lens 200 (lens apparatus) according to the exemplary embodiment of the present disclosure will be described with reference to FIGS. 2 and 3. FIG. 2 is a sectional view illustrating an infinite state of the interchangeable lens 200 according to the exemplary embodiment of the present disclosure, and FIG. 3 is a sectional view illustrating a close-up state of the interchangeable lens 200 according to the exemplary embodiment of the present disclosure. In FIGS. 2 and 3, the same elements as those of FIG. 1 are denoted by the same reference numerals.

A holding barrel 209 of the interchangeable lens 200 is fixed to the lens mount 207 with screws (not illustrated). The holding barrel 209 holds a guide barrel 210 and a board 211.

A cam barrel 212 is held rotatably around the optical axis at a predetermined angle with respect to the guide barrel 210. A cam groove (not illustrated) and a gear portion 212a are provided on the inner circumference of the cam barrel 212. The guide barrel 210 includes a linear guide groove extending in an optical axis direction. The guide barrel 210 further holds the driving unit 202 fixed with screws.

The driving unit 202 includes a drive source 217, a pinion gear 218, a second gear 219, a third gear 220, and a base member 221.

The drive source 217 is, for example, a stepping motor. The drive source 217 may be any drive source that is capable of moving the lens group L1, such as an ultrasonic motor. The drive source 217 includes a shaft portion 217a and a bearing portion 217b. The bearing portion 217b is disposed at the tip of the shaft portion 217a and reduces shake that can occur when the shaft portion 217a is rotated by the drive source 217.

The pinion gear 218 includes a light shielding plate 218a. A photo-interrupter 222 can detect the number of rotations of the drive source 217 by detecting the light shielding plate 218a provided in the drive source 217. Alternatively, any configuration that can detect the number of rotations of the drive source 217 may be used. Other than using the photo-interrupter 222, for example, magnetism may be used to detect the number of rotations.

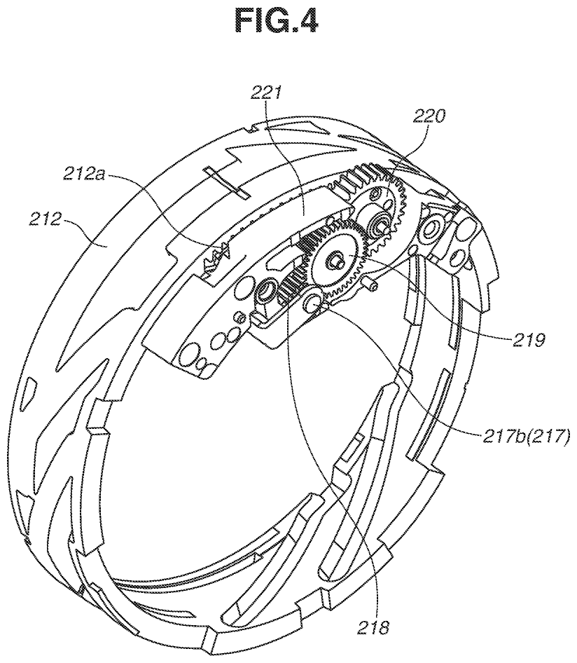

The relationship between the driving unit 202 and the cam barrel 212 will be described with reference to FIG. 4. FIG. 4 is a perspective view of the driving unit 202 and the cam barrel 212. The base member 221 of the driving unit 202 is a member that holds the drive source 217 (the bearing portion 217b), the second gear 219, and the third gear 220 while maintaining predetermined intervals. The cam barrel 212 is provided with the gear portion 212a for transferring the rotation of the third gear 220. In this way, the driving unit 202 can rotate the cam barrel 212 around the optical axis.

The interchangeable lens 200 according to the exemplary embodiment of the present disclosure includes, from the subject side in the optical axis direction, a lens L11, the diaphragm 201, lenses L12 and L13, a lens L14 as a second lens, a lens L15 as a first lens, and a lens L16.

Although the lens L14 is described as the second lens, the lens L16 may serve as the second lens. In the exemplary embodiment of the present disclosure, the lens L16 is a parallel plate having practically no refractive power. Although it is desirable that the lens L16 be a parallel plate for downsizing, the lens L16 may be a spherical lens that has a refractive power.

A first lens holding frame 213 holds the lens L11 and the diaphragm 201. A second lens holding frame 214 holds the lenses L12 and L13. A third lens holding frame 215 holds the lenses L14 and L15. A fourth lens holding frame 216 holds the lens L16. The first lens holding frame 213 and the second lens holding frame 214 are held adjustably with respect to the third lens holding frame 215. The fourth lens holding frame 216 is fixed with respect to the third lens holding frame 215.

The third lens holding frame 215 (the holding frame that holds the first and second lenses) holds a cam follower (not illustrated). Because the cam groove of the guide barrel 210 engages with the linear guide groove of the cam barrel 212, the third lens holding frame 215 is held to be able to move back and forth in the optical axis direction. Because the gear portion 212a of the cam barrel 212 and the third gear 220 of the driving unit 202 engage with each other, the cam barrel 212 is driven around the optical axis.

This allows the lenses L11 to L16 to integrally move in the optical axis direction.

Although the lenses L11 to L16 can integrally move in the direction along the optical axis in the exemplary embodiment of the present disclosure, a part of the lenses may be fixed. For example, the lens L15 or the lens L16 may be held by the lens mount 207 via a holding member.

As illustrated in FIGS. 2 and 3, the board 211 is disposed overlapping a part of the driving range of the lens L14 or the lens L15 in the optical axis direction (when viewed from the direction orthogonal to the optical axis). The board 211 is electrically connected to the lens-side terminal 208 and the driving unit 202 and supplies electric power to the driving unit 202.

As illustrated in FIGS. 2 and 3, the driving unit 202 is disposed overlapping a part of the driving range of the lens L14 or the lens L15 in the optical axis direction. In particular, the shaft portion 217a of the drive source 217 included in the driving unit 202 is disposed overlapping a part of the driving range of the lens L14 or the lens L15 in the optical axis direction. In addition, the driving unit 202 is disposed closer to the image plane than the object-side end surface 207a of the lens mount 207 in the optical axis direction. Specifically, a part of the shaft portion 217a and a part of the base member 221, and the bearing portion 217b of the driving unit 202 are disposed closer to the image plane than the object-side end surface 207a.

Further, a part of the driving unit 202 is disposed overlapping a part of the lens-side terminal 208 in the optical axis direction. As illustrated in FIGS. 2 and 3, an area surrounded by a dotted line from the image plane-side surface that comes into contact with the camera-side terminal to the board 211 is the lens-side terminal 208. In addition, a part of the driving unit 202 is disposed overlapping a part of the driving range of the diaphragm 201, the lens L12, and the lens L13 in the optical axis direction. In the exemplary embodiment of the present disclosure, the driving unit 202 moves the holding frame that holds the lens L14 and the lens L15 in the optical axis direction. However, with the lens L14 (L15) fixed, the driving unit 202 moves a holding frame that holds a different lens in the optical axis direction.

### (Configuration of Lenses)

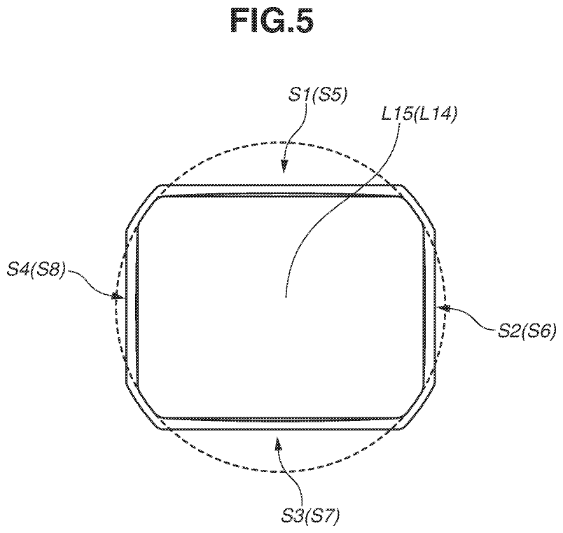

A configuration of the lens L15 (lens L14) according to the exemplary embodiment of the present disclosure will be described with reference to FIG. 5. FIG. 5 is a plan view of the lens L15 as the first lens and the lens L14 as the second lens according to the present exemplary embodiment of the present disclosure, when viewed from the direction along the optical axis.

As illustrated in FIG. 5, the lens L14 and the lens L15 each have a non-circular shape (rectangular shape) obtained by cutting out (removing) a portion of the lens surface that does not contribute to image forming on a light receiving surface (the image sensor 303 of the camera body 300). As described above, in the lens group L1 included in the interchangeable lens 200 according to the exemplary embodiment of the present disclosure, the lenses L14 and L15, which are disposed closer to the image plane than the lenses L11, L12, and L13 (circular lenses), can be formed in a non-circular shape. A first cutout portion (first area) is formed in the lens L15 (first lens), and a second cutout portion (second area) is formed in the lens L14 (second lens). Specifically, although the lens L15 is originally a circular lens, the lens L15 is formed to be a non-circular lens having areas S1, S2, S3, and S4 as the first cutout portion by removing upper, right, lower, and left areas of the originally circular lens. Similarly, although the lens L14 is originally a circular lens, the lens L14 is formed to be a non-circular lens having areas S5, S6, S7, and S8 as the second cutout portion by cutting out (removing) upper, right, lower, and left areas of the originally circular lens.

The lens L14 and the lens L15 are each a plastic lens that is molded in a mold. Although the lenses according to the exemplary embodiment of the present disclosure are plastic lenses, the lenses are not limited to plastic lenses. A lens made of a material other than plastic may be used. In addition, although the above lenses according to the exemplary embodiment of the present disclosure are each molded into a non-circular shape as illustrated in FIG. 5, these lenses may each be created by cutting (cutting out from) a circular lens.

In the case of a lens formed into a non-circular shape, when a circumscribed circle (circle indicated by a dotted line in FIG. 5) centered on the optical axis of the lens is assumed and viewed from the direction along the optical axis, the difference between the circumscribed circle and the non-circular lens can be regarded as the cutout portion.

Among the lenses included in the interchangeable lens 200 according to the exemplary embodiment of the present disclosure, each of the lenses (lenses L11, L12, and L13) disposed closer to the object than the non-circular lenses (lenses L14 and L15) can be a circular lens smaller than the circumscribed circle described above. Thus, when viewed from the direction orthogonal to the optical axis, a part of the driving range of the lenses L12 and L13 can be disposed overlapping a part of the driving unit 202.

According to the exemplary embodiment of the present disclosure, the upper, lower, left, and right areas of the lens L14 and the lens L15 are removed. However, it is only necessary that at least a partial area of a lens be removed, and when viewed from the direction along the optical axis, a part of the driving unit 202 be located in the removed area.

The lens L14 and the lens 15 each have an aspheric surface. This allows the interchangeable lens 200 to be configured with a small number of lenses. However, the present disclosure is not limited to this example. The lens L14 and the lens L15 may each be a spherical lens.

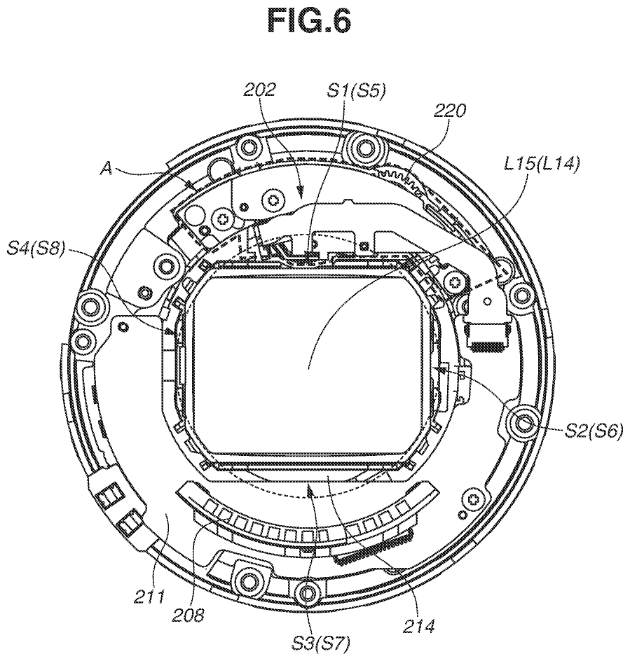

FIG. 6 is a rear view of the interchangeable lens 200 viewed from the direction along the optical axis. In FIG. 6, some of the parts of the interchangeable lens 200 are not illustrated. As illustrated in FIG. 6, when the interchangeable lens 200 is viewed from the direction along the optical axis, a part of the driving unit 202 (area A in which the driving unit 202 is disposed) is disposed in the cutout area S1 (first part area) and the cutout area S5 of the lens L15 and the lens L14.

As illustrated in FIG. 6, when the interchangeable lens 200 is viewed from the direction along the optical axis, a part of the board 211 is disposed in the cutout area S3 (second part area) and the cutout area S7 of the lens L15 and the lens L14. Alternatively, a part of the board 211 may be disposed in the cutout area S2 (third part area) and the cutout area S6 of the lens L15 and the lens L14. Still alternatively, a part of the board 211 may be disposed in the cutout area S4 (fourth part area) and the cutout area S8 of the lens L14 and the lens L15.

Although a part of the driving unit 202 and a part of the board 211 are disposed in cutout areas of the lens L14 and the lens L15 in the exemplary embodiment of the present disclosure, a driving motor for the diaphragm 201 may be disposed.

The effects of the interchangeable lens 200 according to the exemplary embodiment of the present disclosure configured as described above will be described.

When the interchangeable lens 200 is viewed from the direction orthogonal to the optical axis, a part of the driving range of the lens L15 overlaps the object-side end surface 207a of the lens mount 207, and a part of the driving unit 202 is disposed in the area S1, which is a cutout portion of the lens L15. In this way, since the driving unit 202 can be disposed closer to the optical axis of the lens L15, the interchangeable lens 200 can be downsized in the radial direction.

Further, when the interchangeable lens 200 according to the exemplary embodiment of the present disclosure is viewed from the direction orthogonal to the optical axis, a part of the driving unit 202 is disposed closer to the image plane than the object-side end surface 207a of the lens mount 207. As a result, the interchangeable lens 200 can be downsized in the optical axis direction more than the case where the driving unit 202 is disposed closer to the object than the object-side end surface 207a of the lens mount 207.

When the interchangeable lens 200 according to the exemplary embodiment of the present disclosure is viewed from the direction orthogonal to the optical axis, a part of the driving range of the lens group L1 (lenses L15 and L14) overlaps a part of the driving unit 202. Further, when the interchangeable lens 200 is viewed along the optical axis, the area S1, which is a cutout portion of the lens L15, and the area S5, which is a cutout portion of the lens L14, overlap a part of the driving unit 202. In this way, even when the lens L14 and the lens L15 are driven along the optical axis and the locations thereof overlap with the driving unit 202 in the optical axis direction, the driving unit 202 can still be disposed closer to the optical axis. Thus, the interchangeable lens 200 can be downsized in the radial direction.

When the interchangeable lens 200 according to the exemplary embodiment of the present disclosure is viewed from the direction orthogonal to the optical axis, a part of the board 211 is disposed overlapping the area S3 (second part area) and the area S7, which are cutout portions of the lens L15 and the lens L14. Further, since the areas S2, S4, S6, and S8 are provided as cutout portions, the board can be disposed to be closer to the optical axis. As a result, because the board area can be increased in the direction of the inner diameter, the outer diameter of the board can be reduced. Thus, the interchangeable lens 200 can be downsized.

The interchangeable lens 200 according to the exemplary embodiment of the present disclosure includes an imaging optical system that forms an optical image of an object (subject). An imaging light flux from the object passes through the imaging optical system (lens group L1) and forms an image on the light receiving surface (imaging surface) of the image sensor 303. The image sensor 303 photoelectrically converts the optical image of the object formed by the imaging optical system.

Although the exemplary embodiment of the present disclosure has thus been described, the present disclosure is not limited to the above exemplary embodiment. Various modifications and variations can be made within the scope of the gist of the present disclosure. The present disclosure is applicable to a lens barrel that can be mounted on a camera body of a single-lens reflex digital camera, a mirrorless camera, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-022700, filed Feb. 16, 2023, which is hereby incorporated by reference herein in its entirety.

What is claimed is:

1. A lens apparatus comprising:
a holding frame configured to hold a first lens;
a driving unit configured to drive the holding frame in a direction along an optical axis; and
a mount configured to mount the lens apparatus on an imaging apparatus,
wherein, when the lens apparatus is viewed from the direction along the optical axis, at least a part of the driving unit is disposed inside a circumscribed circle of the first lens having a non-circular shape, and
wherein a part of the first lens is disposed at a location that overlaps an object-side end surface of the mount or is disposed closer to an image plane than the object-side end surface of the mount in the direction along the optical axis.

2. The lens apparatus according to claim 1, wherein at least a part of the driving unit overlaps the first lens in the direction along the optical axis.

3. The lens apparatus according to claim 1, wherein at least a part of the driving unit is disposed closer to an image plane than the object-side end surface of the mount in the direction along the optical axis.

4. The lens apparatus according to claim 1, wherein at least a part of a driving range of the holding frame overlaps the object-side end surface of the mount or is closer to the image plane than the object-side end surface of the mount in the direction along the optical axis.

5. The lens apparatus according to claim 1, comprising a board configured to electrically connect to the driving unit,
wherein an outer circumference of the first lens includes a first area inside the circumscribed circle,
wherein the first area includes a first part area and a second part area, and
wherein, when the lens apparatus is viewed from the direction along the optical axis, at least a part of the driving unit is disposed in the first part area, and at least a part of the board is disposed in the second part area.

6. The lens apparatus according to claim 5,
wherein the first area includes a third part area and a fourth part area, and
wherein, when the lens apparatus is viewed from the direction along the optical axis, at least a part of the board is disposed in the third part area and the fourth part area.

7. The lens apparatus according to claim 5, wherein at least a part of a driving range of the holding frame overlaps the board in the direction along the optical axis.

8. The lens apparatus according to claim 1, wherein the first lens is a plastic lens.

9. The lens apparatus according to claim 1, wherein the first lens is an aspherical lens.

10. The lens apparatus according to claim 1, comprising a second lens having a non-circular shape,
wherein an outer circumference of the second lens includes a second area inside a circumscribed circle centered on the optical axis, and
wherein the second lens is disposed on the image plane side or an object side with respect to the first lens.

11. The lens apparatus according to claim 10, wherein at least a part of the driving unit overlaps the second area in the direction along the optical axis.

12. The lens apparatus according to claim 10, wherein the second lens is a plastic lens.

13. The lens apparatus according to claim 10, wherein the second lens is an aspherical lens.

14. The lens apparatus according to claim 10, wherein the non-circular shape of the second lens obtained by cutting out a part of a lens surface that does not contribute to image forming on a light receiving surface of the imaging apparatus.

15. The lens apparatus according to claim 1, comprising a terminal unit configured to electrically connect to the imaging apparatus,
wherein at least a part of the terminal unit overlaps the first lens in the direction along the optical axis.

16. The lens apparatus according to claim 15, wherein at least a part of the driving unit overlaps the terminal unit in the direction along the optical axis.

17. The lens apparatus according to claim 1, wherein the non-circular shape of the first lens obtained by cutting out a part of a lens surface that does not contribute to image forming on a light receiving surface of the imaging apparatus.

18. A lens apparatus comprising:
a first lens;
a holding frame configured to hold a lens different from the first lens;
a driving unit configured to drive the holding frame in a direction along an optical axis; and
a mount configured to mount the lens apparatus on an imaging apparatus,
wherein, when the lens apparatus is viewed from the direction along the optical axis, at least a part of the driving unit is disposed inside a circumscribed circle of the first lens having a non-circular shape, and
wherein a part of the first lens is disposed at a location that overlaps an object-side end surface of the mount or is disposed closer to an image plane than the object-side end surface of the mount in the direction along the optical axis.

19. An imaging apparatus comprising:
a lens apparatus; and
an image sensor configured to receive light from the lens apparatus,
wherein the lens apparatus includes:
a holding frame configured to hold a first lens;
a driving unit configured to drive the holding frame in a direction along an optical axis; and
a mount configured to mount the lens apparatus on the imaging apparatus,
wherein, when the lens apparatus is viewed from the direction along the optical axis, at least a part of the driving unit is disposed inside a circumscribed circle of the first lens having a non-circular shape, and
wherein a part of the first lens is disposed at a location that overlaps an object-side end surface of the mount or is disposed closer to an image plane than the object-side end surface of the mount in the direction along the optical axis.
